(19) United States
(12) Patent Application Publication
(10) Pub. No.: US 2024/0057501 A1
(43) Pub. Date: Feb. 22, 2024

(54) MACHINE READABLE OPTICAL IMAGES FOR GNSS-DENIED NAVIGATION AND LOCALIZATION OF A WORKING MACHINE

(71) Applicant: Kubota Corporation, Osaka (JP)

(72) Inventors: Kyle A. MARTIN, Fort Worth, TX (US); Nicholas Richardson, Fort Worth, TX (US); Bruce Jeffrey Thompson, Victoria (CA)

(73) Assignee: Kubota Corporation, Osaka (JP)

(21) Appl. No.: 18/235,767

(22) Filed: Aug. 18, 2023

Related U.S. Application Data
(60) Provisional application No. 63/399,518, filed on Aug. 19, 2022.

(51) Int. Cl. A01B 69/00; A01B 69/04; G05D 1/02; G05D 1/00

(52) U.S. Cl. CPC A01B 69/001; A01B 69/008; G05D 1/0234; G05D 1/0242; G05D 1/0278; G05D 1/0061; G05D 2201/0201

(57) ABSTRACT

Some embodiments may include a working machine to perform one or more work tasks in a work area, the working machine comprising: a machine localization system to localize the working machine based on perception sensor observations indicative of data embedded on one or more markers placed in the work area or proximate to the work area, wherein the working machine obtains localization data responsive to reading one or more machine-readable optical images on the one or more markers, respectively, wherein the working machine determines, using the obtained localization data, an absolute position of the working machine or one or more absolute positons of the one or more markers, respectively; and wherein the working machine performs the one or more work tasks based on the determined absolution position(s). Other embodiments may be disclosed and/or claimed.

### PRIORITY

This application is a non-provisional of U.S. Provisional Application No. 63/399,518 filed on Aug. 19, 2022, which is incorporated by reference herein.

### TECHNICAL FIELD

The present disclosure relates to off-highway working vehicles and other working machines, and some embodiments relate to machine readable optical images for GNSS-denied navigation and localization.

### BACKGROUND

Off-highway working vehicles or other working machines, which may operate on steep or uneven ground, may include utility vehicles, such as tractors, lawnmowers, construction vehicles, agriculture vehicles, mining vehicles, or the like. These working machines may have transportation systems, such as wheels, treads, walking devices, crawlers, or the like, to transport the working machine from one location to another. A motorized transportation system may be powered by any power source, such as a combustion engine, an electric motor, or the like, or combinations thereof.

In addition to the transportation system, these working machines may include tools for performing a work task, such as a residential operation, commercial operation, or industrial operation. Example work tasks may include mowing, spraying, harvesting, planting, digging, mining, leveling, or the like. These tools may also be referred to as implements, and may include:
Passive implements such as a plow that is pulled by a tractor, a trailer with a non-motorized transportation system, or the like; and
Motorized implements, such as a powered hitch to position a plow, a mower, a digger, a lawn edger, or the like.

Various components of these working machines (e.g., motorized devices of the transportation system and/or a motorized implement), may be configured to operate autonomously (e.g., fully autonomously or semi-autonomously). A robotic lawn mower is one example of a working machine that may operate fully autonomously. A tractor having an auto-steering system interfacing with the steering wheel (or steering wheel column) is one example of a semi-autonomous working vehicle (because an operator may manually steer the vehicle using the steering wheel).

### BRIEF DESCRIPTION OF THE DRAWINGS

FIG. 1 is a schematic view of a system including a working machine and at least one marker including indicia denoting a machine-readable optic image, according to various embodiments.

FIG. 2 is a schematic view of a work area bounded by markers, according to various embodiments.

FIG. 3 is a schematic view of an area containing at least one marker located at a predefined position, according to various embodiments.

FIG. 4 is a flow chart illustrating operations that may be performed by a controller of a working machine to localize the working machine based on marker observations, according to various embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

A working machine such as a drone, robot, or the like, may include a machine localization system. In many working machines, the machine localization system is Global Navigation Satellite System (GNSS) based. That is, the machine localization system is coupled to one or more GNSS receivers, such as Global Positioning System (GPS) receiver(s) located on the machine, and performs localization from data generated by the GNSS receiver(s). Localization may include the working machine determining an absolute position using the data generated by the GNSS receiver(s).

High precision GNSS-based machine localization systems may require more than one GNSS receiver and/or a high accuracy GNSS receiver, which may be a relatively significant build cost and/or result in relatively high operating cost of the GNSS system. Also, these known machine localization systems may be complex to setup and maintain, which may further increase operating costs. For example, real-time kinetic positioning (RTK) may be used (to correct for common errors in GNSS systems), which may require an additional layer of setup difficulty and cost.

Known machine localization systems may also be dependent on GNSS being available or accurate, which may depend on weather, overhead interference, or geographic location. With systems relying on known machine localization systems (which may depend on GNSS reception), with bad weather or other conditions producing low precision, work tasks may not be performed quickly enough to get an application completed in time (e.g., agricultural tasks that may be time-sensitive based on a growing season). Alternatively, systems relying on known machine localization systems may not get those work tasks complete with the precision needed to optimize productivity (e.g., crop production). If GNSS is the sole system used for localization, loss of the GNSS signal may also cause the machine to operate in an unsafe condition.

Various embodiments described herein may involve a machine location system that receives an input from one or more perception sensors on the working machine (e.g., sensors that collect data used to operate any perception systems, now know or later developed), in addition to a low cost GNSS receiver circuitry/service (e.g., a single low cost GNSS receiver on the machine and/or a low cost GNSS service). Examples of perception sensors may include LiDAR sensors, cameras, radar, etc. The working machine's autonomous system's positioning and performance can be made confident through any operations described herein (e.g., ego-vehicle or other ego-machine localization operations described herein), even when GNSS accuracy of the low cost GNSS receiver and/or low cost GNSS service is lower than an accuracy of known GNSS-based machine localization systems.

In various embodiments, one or more markers containing machine readable optical images may be placed around a particular location or environment (e.g., a farming field). In some embodiments, these markers may be IR (infrared) markers that may include indicia visible in the IR spectrum (e.g., IR codes, which in some examples may be similar in various respects to QR (quick-response) codes, hereinafter “IR QR codes” to refer to those embodiments), and may serve as unique landmarks for working machine software to position itself within a world coordinate frame with the use of, potentially, a graph-SLAM algorithm.

The indicia on the one or more markers may be observed in a LiDAR point cloud, e.g., IR markers may be observed in a LiDAR point cloud. In various embodiments, a LiDAR sensor on the working machine may illuminate the environment with an IR flash or directed IR diode beams (this may be performed in any ambient lighting condition, such as low light levels caused by bad weather and/or low light conditions based on time of day). In some embodiments, the IR markers may be observed with an IR flood light or an IR camera as well. These sensing methods may be combined to further increase detection confidence. The indicia of the IR markers may be extracted from an environment using any method described herein.

In various embodiment, each markers may have a rugged metal or plastic body (e.g., a 1 foot by 1 foot square plate, in one example) with at least one surface having a unique pattern printed thereon. In examples in which the marker is an IR marker, the unique pattern may be printed with a specialized ink or paint arranged to effectively reflect IR light in a range of about 800 nm to 940 nm.

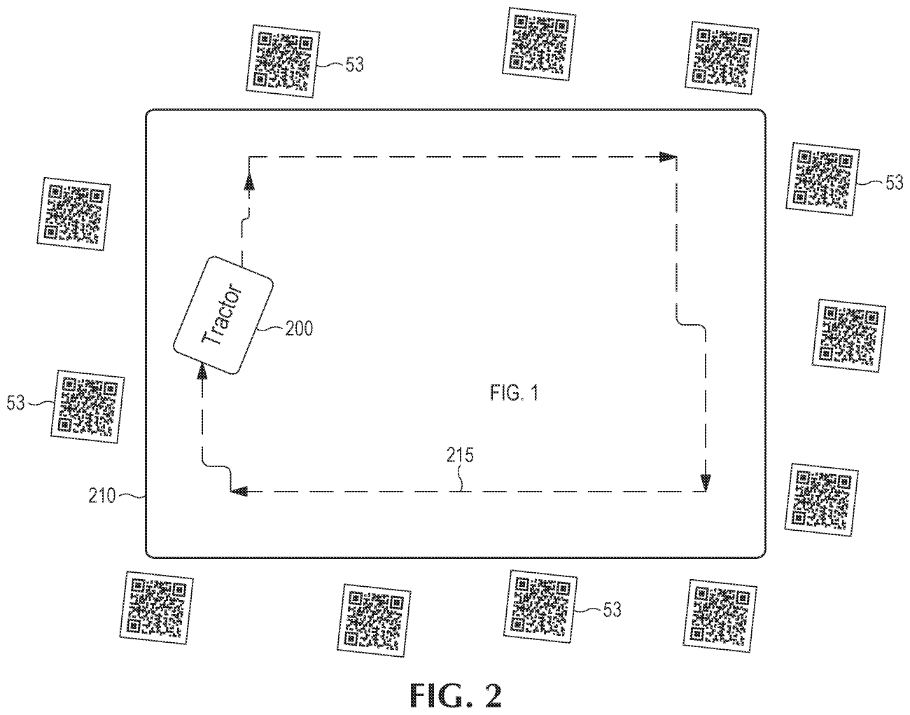

In some embodiments, the markers may be placed in and/or around an operational area for the working machine. FIG. 2 illustrates an example in which the markers are arranged around a perimeter of the operational area.

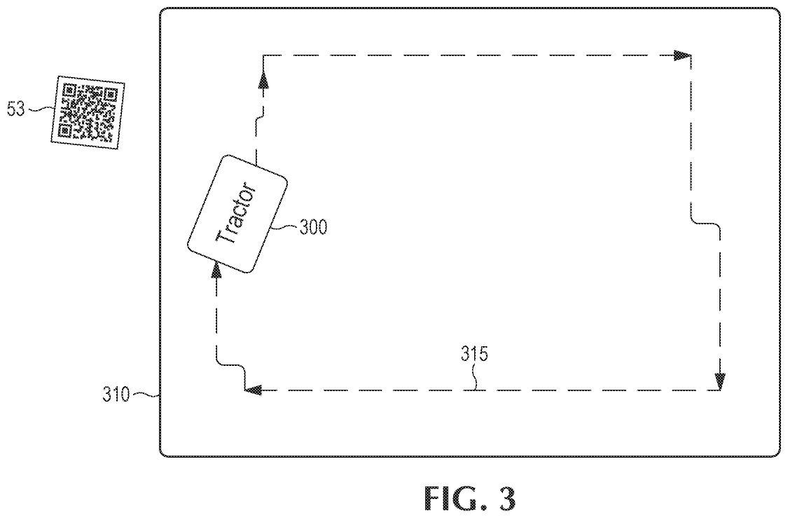

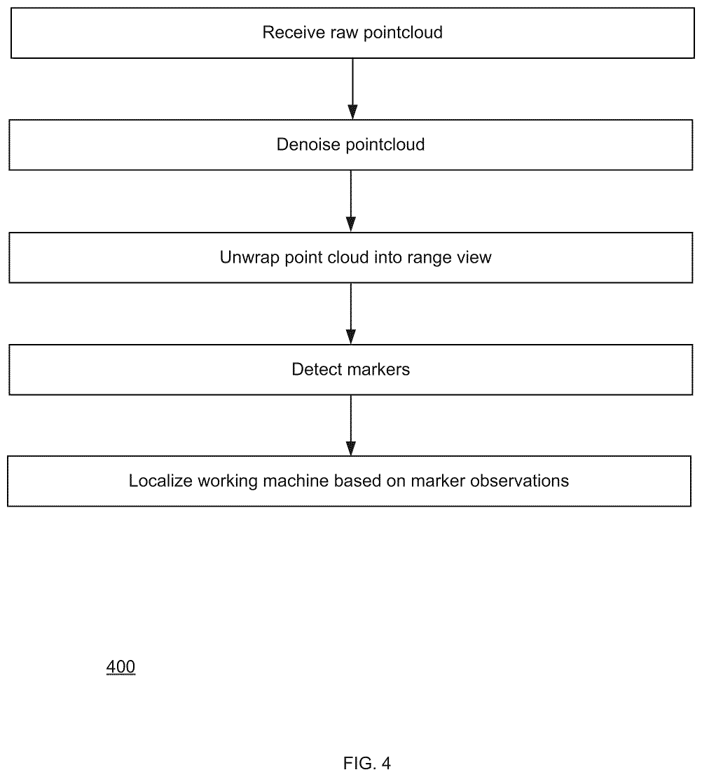

Although this example shows the markers placed around a perimeter of the operational area, this is not required. In other embodiments, one or more markers may be placed at one or more predefined positions in an area, which is illustrated in FIG. 3. The one or more markers can be extracted from the environment via the operations 400 shown in FIG. 4:

In various embodiments, a setup process of a system include markers for localization may include:
Operator places markers around a boundary of an environment (for IR markers, perhaps attached to a metal post that has been painted with IR reflective paint);
Operator places a system of a working vehicle into a “mapping” mode;
Operator drives the working vehicle around the boundary of environment to collect data about placement of markers; and/or
System generates a landmark map and saves to storage.

In various embodiments, a process following setup (e.g., a process to utilize the system) may:
Operator loads map of environment via GUI;
Operators chooses field or other work task;
System turns on sensors and determines machine location based on observed marker(s); and/or
System autonomously performs the field or other work task.

In some embodiments, the system may have various sensors used for navigating the field or other work area while autonomously performing the work task. In some embodiments, a perception sensor operable in the IR spectrum may be additionally used to read IR markers during navigation, and to fuse readings from this with the other various sensors used for navigation in the field or other work area while autonomously performing the work task. With markers placed along a perimeter as shown, this may increase the confidence of detecting a headland of the field or other work area, keeping the working machine within the field or other work area, or the like.

In various embodiments, a working machine may include a memory and one or more processors. The memory may store instructions that, when executed by the one or more processors, perform any localization operations or other operations described herein. The processor may be coupled to, or part of, any machine localization system described herein. In some embodiments, the processor may perform sensor fusion to perform high confidence localization using low cost GNSS components (e.g., a low cost GNSS receiver and/or a low cost GNSS service) in combination with any perception sensor now know, or later developed. The processor may also be operable to rely on perception sensor input exclusively in the event of a GNSS exception.

### Marker Features

In one embodiment, a marker may have a first region including an indicia (e.g., a perception sensor-readable optical image) and a second region with an area of higher reflectively than areas of the first region. The working machine perception sensor(s) may be configured to operate in a first mode optimized to discover the marker based on the second region (e.g., a default resolution scan).

Discovery of the marker using the second region may trigger the same or another perception sensor to operate in a second mode optimized to read the indicia from the first region, e.g., the discovery of the second region may define a specific location to perform a higher resolution scan at the specific location, to read the indicia.

In one embodiment, the second region may be part of the marker's post or other supporting section (e.g., a marker post painted with paint that is highly reflective of IR light, in an example in which the markers are IR markers). The first region may located on the marker itself. In various embodiments, the second region may use a different ink formulation than the first region. In other examples, the second region may have a continuous non-interrupted section of the same ink formulation.

In any embodiment described herein, the unique value indicated by the indicia may be mathematically generated similar to any software protection codes, now known or later developed. The indicia may be generated via a secret algorithm similar to how software serial keys are generated for high-value software packages.

In various embodiments, the marker has a QR code scannable using IR as its indicia. However, a QR code is only one type of scannable code (e.g., computer readable optical image), and other embodiments may use some other type of scannable code, such as a bar code or any other scannable image or code now known or later developed. In various embodiments, the computer readable optical image may be a linear code or one-dimensional computer readable optical image, a matrix code or some other two-dimensional computer readable optical image, or the like, or combinations thereof.

In various embodiments, the indicia may be scannable in the IR spectrum. However, in various embodiments, it may be possible and practical to use indicia scannable in other wavelengths, particularly wavelengths that suited for scanning by a perception sensor in bad weather or other poor lighting conditions.

In various embodiments geographic information and/or information about a work task to be performed by the working machine may be recoverable using only the machine readable optical image. However, in other examples, an intermediary value may be recoverable using the machine readable optical image (e.g., an intermediary value may be embedded in the machine readable optical image), and the working machine may use that intermediary value to obtain geographic information and/or information about a work task. For example, the working machine may include a table correlating intermediary values to geographic information and/or information about a work task. The working machine may derive the geographical information and/or other information about the work task from the table using the intermediary value. In some embodiments, the working machine may be coupled to a nearby resource, such as wirelessly coupled to an operator's mobile phone (e.g., via a short range wireless connection, such as a Bluetooth connection or a Near Field Connection). In these embodiments, the working machine may identify the intermediary value by scanning the machine readable optical image using its perception sensor. Then, the working machine may provide the intermediary value to the nearby resource (via the short range wireless connection), which may return the geographic information and/or information about a work task. In yet other embodiments, the machine may determine a resource locator, such as a uniform resource locator (URL) by scanning the machine readable optical image using its perception sensor. Then the working machine may use a WiFi connection to access the determined resource locator in order to obtain the geographic information and/or other information about a work task to be performed in the work area by the working machine. The use an intermediary value may allow the markers to be manufactured with a resource locator or other intermediary value, and an operator may update information accessible using the resource locator (which may allow the same marker with the fixed value to be used with geographically different work areas).

In other embodiments, the marker may be a digital sign or other electronic display capable of displaying a QR code or other machine readable optic image. In these embodiments, the QR code or other machine readable optic image may be reconfigured depending on work requirements.

### Point to Point Navigation Using Markers

Some embodiments described herein may use markers to identify a boundary of a work area (e.g., an entire perimeter of a work area, or any part of a boundary of a work area). This is depicted in FIG. 2, in which a plurality of markers 53 is used by a working machine (e.g., tractor 200) to identify a work area 210 and plan a route 215 through that work area 210.

In various embodiments, one or more markers with one or more QR codes (e.g., IR QR codes) or other machine readable optical images (e.g., other IR machine readable optical images) may be placed at the beginning, end, or anywhere in between rows of specialty crops (e.g., vineyards, orchards, horticulture, etc.) These markers may serve as unique landmarks for the working machine to utilize to autonomously drive from point to point along a path and/or transition from one row to another, without depending on GNSS or other features for navigation purposes. This is depicted in FIG. 3, in which a marker 53 is used as a unique landmark in a work area 310 that may not have any features (an example of such an area is an unplanted flat field, which may lack features such as trees, crop rows, hills, etc.).

In various embodiments, one or more markers with one or more QR codes or other machine readable optical images may be placed at one or more predefined positions (e.g., one or more specific known geographic locations) to allow the vehicle to recognize where it is in absolute terms (e.g., work area A, row 1 start or work area B row 30 end, or work area refill station 2, etc.) This may allow the working machine to recognize an absolute geographic position in order to perform operations corresponding to its work tasks (e.g., start, pause, unload, finish, etc.) even while navigation using a relative location based on features or some other input. Referring again to FIG. 3, the marker 53 may be placed at a predefined position in the work area 310 to allow the working machine (e.g., tractor 300) to recognize an absolute geographic position in order to navigate the path 315.

Autonomous or semi-autonomous navigation of a working machine around an area based on determining its location relative to features identified using its perception sensor(s) (e.g., cameras, LiDAR, radar, or any other sensor capable of generating visual odometry data, in which a GNSS location or other absolute position of the working machine may not be required, may be referred to herein as a “feature navigation.” Various embodiments may perform feature navigation based at least in part on the values embedded in indicia on a surface of any marker described herein.

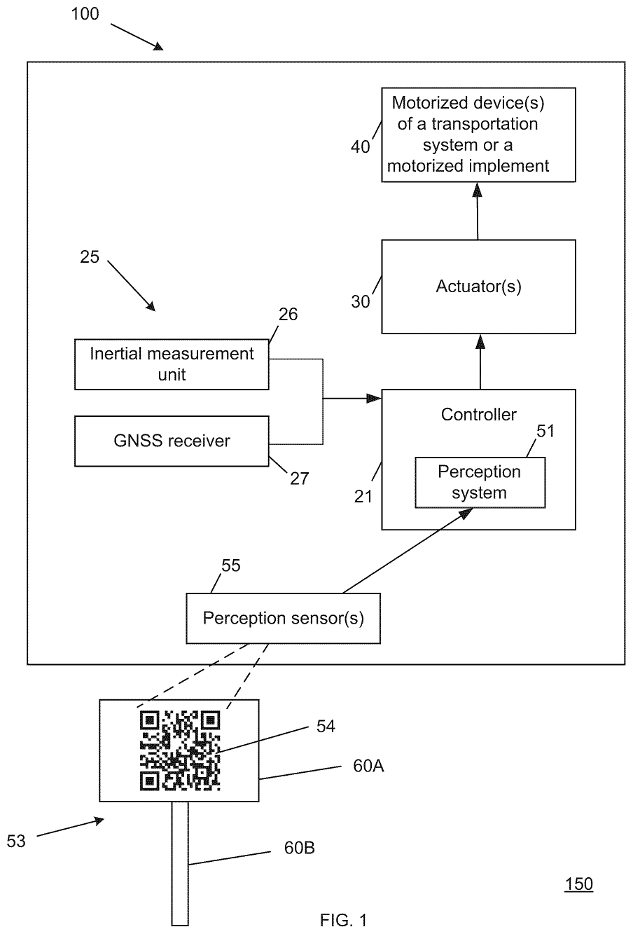

FIG. 1 is a schematic view of a system 150 including a working machine 100 and at least one marker 53. The at least one marker 53 may be similar to any marker described herein (it may include indicia 54 representing a machine-readable optical image). For example, the marker 53 may have a first region 60A including the indicia and a second region 60B with a higher reflectivity region optimized for discovery (e.g., IR discovery) by the one or more perception sensors 55 in a scanning mode of a working machine 100.

The working machine 100 may be similar to any working machine described herein. Perception sensor(s) 55 may include any sensor to drive a perception system 51 implemented by the controller 21 of the working machine (e.g., a camera, LiDAR, radar, or any other perception sensor, now known or later developed). The perception system 51 may drive feature navigation, which may not require GNSS positions.

The working machine 100 may include one or more motorized devices 40, which may be components of a motorized transportation system or the working machine and/or a motorized implement of the working machine. Actuator(s) 30 may drive movement of the motorized devices 40, under control of a controller 21. These motorized device(s) 40 and actuator(s) 30 may include any motorized devices of motorized transportation systems or motorized implements, now known or later developed.

In some embodiments, the actuators 30 may be part of an auto-steering system similar to the auto-steering system described in U.S. Pat. No. 10,822,017 (which is herein incorporated by reference herein), or any other auto-steering system now known or later developed. In some embodiments, the set of one or more processors of the controller 21 may perform any functions of any precision guidance system (PGS) described in U.S. Pat. No. 10,986,767 (which is incorporated by reference herein), such as any of the steering controller functions and/or the processor functions described in that U.S. Patent.

The controller 21 may include a set of one or more processors, which may be implemented using any circuitry now known or later developed. Examples of circuitry that may be used to implement the set of one or more processors may include logic, application-specific processors, general purpose processors to execute instructions stored in a memory, or the like, or combinations thereof. In various embodiments, the controller 21 may plan a mission including autonomously or semi-autonomously performed working tasks in a field or other work area. The controller 21 may autonomously or semi-autonomously operate the actuator(s) 30 and the motorized device(s) 40 based on the mission.

The working machine 100 may utilize any vehicle control system, now known or later developed, that uses visual odometry (VO) to identify a relative position of the working machine. One example of such a vehicle control system is described in U.S. Pat. No. 11,269,346, which is incorporated by reference herein. That vehicle control system is capable of navigating using VO data when GNSS reception is lost. For example, a tractor may navigate between crop rows using VO data when a canopy blocks GNSS reception. The tractor may accurately steer using a relative position (e.g., a position of the tractor relative to a feature, such as crop rows). The tractor may re-calculate its tracked position using an absolute position (determined using GNSS data obtained when GNSS reception is regained—such as when the tractor emerges from crop rows into a headland (where there is no overhead canopy), before the tractor enters the next crop rows).

In various embodiments described herein, the working machine 100 may or may not include a location determining system 25 that may utilize other sensors such as GNSS receiver 27 and inertial measurement unit 26. Instead of recalculating a tracked position associated with feature navigation using a GNSS signal when emerging from crop rows, the controller 21 may recalculate the tracked position using information obtained by scanning the marker 53 with the known geographic location. The indicia 54 may itself contain geographic information, or may contain a value that can be used to determine the geographic information (such as when the marker 53 is placed at a predefined position).

In some embodiments the working machine 100 may rely exclusively on feature navigation techniques and thus may not have the location determining system 25. At times, the controller 21 may also perform feature navigation during the mission, using any feature navigation systems now known or later developed. The feature navigation may not require determination of an absolute position of the working machine 100. As one example, when the working machine 100 is working between crop rows, a canopy may interfere with GNSS signals. At these times, the controller 21 may continue navigating between the crop rows using data captured by the one or more perception sensors 55. The data captured by the one or more perception sensors 55 drives a perception system 51 (which may be any perception system, now known or later developed).

In various embodiments, the indicia 54 may include work task information for the working machine 100. The work task information may be a deviation from a pre-planned mission. For example, the indicia 54 may indicate a detour for the working machine to take. This would allow an operator who does not have access to change the working machine's mission and/or perform a detour without relying on obstacle detection. Instead, the operator may place the marker 53 indicating the detour for the working machine to scan. As one example, an operator may know about an obstacle, such as a ditch, that may be difficult for the working machine's perception system 51 to identify in poor lighting conditions. By placing the marker 53 near the obstacle, the operator may ensure that the working machine 100 will navigate around the obstacle regardless of whether the obstacle is directly recognized in the poor lighting conditions by the perception system 51 or not. The working machine 100 may determine when and how to perform the detour responsive to scanning the indicia 54. In another example, similar to the detour example, an operator may place the marker 53 to instruct the working machine 100 to park itself at a designated location, such as on a trailer or at a specific location in the field or other work area.

The marker 53 may be placed in a predefined position in a work area (e.g., a known geographic location, such as a lat/long position, a GNSS location, or the like), and may contain indicia 54, such as a QR code or some other machine-readable optical image. In some embodiments, the indicia 54 may be optimized for reading in poor lighting conditions, such as reading using an IR-based sensor of the working machine, e.g., may be IR indicia.

During the mission, the controller 21 may perform GNSS navigation and/or feature navigation. In GNSS navigation, the controller 21 may utilize a location determining system 25 including a GNSS receiver (the location determining system 25 may include other sensors such as an inertial measurement unit 26, or any other sensor now known or later developed). The location determining system 25 may continuously determine an absolute position of the working machine 100 based on sensor data from the GNSS receiver 27. The controller 21 may use these absolute positions to navigate around the field or other area to complete the mission.

In various embodiments, the indicia 54 may embed 1) position values (such as a latitude/longitude or other geographic location information) or an intermediary value correlated therewith, and/or 2) other values (e.g., instruction data for use by the working machine 100) in performing one or more work tasks. The controller 21 may autonomously or semi autonomously operate a transportation system and/or implement(s) of the working machine 100 based on the embedded value.

In view of the many possible embodiments to which the principles of the disclosed technology may be applied, it should be recognized that the illustrated embodiments are only preferred examples and should not be taken as limiting the scope of the disclosure.

1. A working machine to perform one or more work tasks in a work area, the working machine comprising:
a machine localization system to localize the working machine based on perception sensor observations indicative of data embedded on one or more markers placed in the work area or proximate to the work area, wherein the working machine obtains localization data responsive to reading one or more machine-readable optical images on the one or more markers, respectively, wherein the working machine determines, using the obtained localization data, an absolute position of the working machine or one or more absolute positons of the one or more markers, respectively; and
wherein the working machine performs the one or more work tasks based on the determined absolution position(s).

2. The working machine of claim 1, wherein the working machine localization receives input from one or more GNSS (global navigation satellite system) receivers of the working machine, in addition to the perception sensor observations indicative of the data embedded on one or more markers .

3. The working machine of claim 2, wherein the machine localization system is arranged to attempt to localize based on the input from the one or more GNSS receivers and the perception sensor observations, if both are available.

4. The working machine of claim 3, wherein the machine localization system is arranged to localize based exclusively on the data embedded on one or more markers in the event of a GNSS exception.

5. The working machine of claim 1, wherein the machine-readable optical images are reflective in a spectrum outside the human-visible spectrum.

6. The working machine of claim 5, wherein the spectrum comprises the IR (infrared) spectrum.

7. The working machine of claim 1, wherein the machine-readable optical image comprise a one-dimensional or two-dimensional code.

8. The working machine of claim 7, wherein the machine-readable optical image comprise an IR QR (quick response) code.

9. The working machine of claim 1, wherein the one or more work tasks are part of a mission definition, wherein the embedded data includes detour information delineating one or more deviations from the mission definition.

10. The working machine of claim 9, wherein the deviations define at least one work task that is different than the one or more work tasks.

11. An apparatus, comprising:
a set of one or more markers embedded with data usable by a machine localization system to localize a working machine in an area, wherein each marker comprises:
a surface having thereon indicia scanable using one or more perception sensors of the working machine, wherein the indicia comprises a QR (quick response) code or other machine-readable optical image representing a portion of the data.

12. The apparatus of claim 11, wherein each QR code or other machine-readable optical image is located in a first region of the corresponding marker, wherein the apparatus further comprises a second region having one or more markings suitable for discovery by one or more perception sensors of a working machine in a scanning mode during bad weather or other low light conditions.

13. The apparatus of claim 12, wherein the one or more markings comprise IR (infrared) markings.

14. The apparatus of claim 13, wherein the indicia comprises IR indicia.

15. The apparatus of claim 14, wherein the IR markings in the second region have a different reflectivity than the indicia of the first region, wherein the IR markings of the second region optimized for IR discovery

16. The apparatus of claim 12, wherein the one or more markers are mountable using one or more support structures attachable to the one or more markers, respectively, and wherein the second region is located on a support structure of the one or more support structures.

17. A method, comprising:
placing markers around the boundary of an environment;
manually driving a working machine around the boundary of the environment in which an automation subsystem of the working machine operates in mapping mode while the working machine is manually driven; and
choosing an automated field task using a user interface of the working machine;
wherein the working machine reads unique identifiers on the markers using its perception sensor(s), and localizes using the unique identifier data in combination with information generated in the mapping mode, and then performs one or more working tasks by autonomously or semi-autonomously operating one or more transportation devices of the working machine or one or more implements of the working machine.
